(19) United States
(12) Patent Application Publication
(10) Pub. No.: US 2019/0184599 A1
(43) Pub. Date: Jun. 20, 2019

(54) SYSTEM FOR TREATING A REFRACTORY BATCH, USE OF SUCH A SYSTEM, METHOD FOR TREATING A REFRACTORY BATCH, AND USE OF A MOULD

(71) Applicant: Refractory Intellectual Property GmbH & Co. KG, Wien (AT)

(72) Inventors: Patrick Seitz, Trofaiach (AT); Helmut Kaufmann, Gaishorn/See (AT)

(21) Appl. No.: 16/091,453

(22) PCT Filed: Apr. 29, 2016
(86) PCT No.: PCT/EP2016/059636

§ 371 Date: Oct. 4, 2018

(51) Int. Cl. B28B 7/00; C04B 35/64; B28B 1/14; B28B 11/24

(52) U.S. Cl. CPC B28B 7/0029; C04B 35/64; C04B 2235/96; B28B 11/243; B28B 1/14

(57) ABSTRACT

The invention relates to a system for treating a refractory batch, a use of the system, a method for treating a refractory batch, and a use of a mould.

The invention relates to a system for treating a refractory batch, a use of the system, a method for treating a refractory batch, and a use of a mould.

The system according to the invention is used for treating a refractory batch for producing a refractory ceramic product.

The term “refractory ceramic product” within the sense of the invention denotes in particular refractory products having a working temperature of more than 600° C. and preferably refractory materials according to DIN 51060:2000-6, that is to say materials with a pyrometric cone equivalent >SK 17. The parametric cone equivalent may be determined in particular in accordance with DIN EN 993-12:1997-06.

A “refractory batch”, as is known, denotes a composition formed of one or more components of raw materials by which a refractory ceramic product can be produced by means of a heat treatment, that is to say in particular by means of ceramic firing or by means of melting.

Refractory ceramic products are known in many forms. Refractory ceramic products thus can be present in the form of unshaped products (what are known as “masses”) or in the form of shaped products. Shaped refractory products can be divided in turn into shaped products in the form of bricks, which are used in particular for providing assemblies, and into functional products, which perform a function, for example a function in the casting of steel.

For the production of refractory ceramic products in the form of functional products, the shaping thereof by isostatic pressing is known. As is known, in the case of isostatic pressing a batch for producing the functional product is firstly introduced into the cavity of a resilient mould. The resilient mould is then acted on with pressure in a pressure vessel from all sides by means of a liquid, such that the resilient mould transfers the pressure on all sides to the batch. Since the inner contour of the cavity corresponds to the shape of the functional product to be produced, the batch is hereby pressed so as to form a green body which has the shape of the functional product to be produced. After the pressing of a green body of this kind in the resilient mould, the green body is removed from the mould and is then further processed to form a refractory ceramic functional product. For the further processing of the green body into a refractory ceramic functional product, the green body is fired to form a refractory ceramic body by exposure to heat, optionally after a prior drying.

Insofar as a green body is produced by isostatic pressing in order to produce a functional product in the form of a carbon-bonded product, it is known from the prior art to transport the green body in un-fired form to the site of use of the functional product to be produced from the batch and to fire it there to form a carbon-bonded refractory ceramic product. A method of this kind is known for example for the production of monoblock stoppers for the tundish in continuous casting systems. Here, an isostatically pressed green body, for production of a monoblock stopper, is arranged in the un-fired state at the later site of use of the monoblock stopper in the tundish, and the monoblock stopper is then fired, by heating of the tundish, to form a functional product in the form of a carbon-bonded refractory ceramic shaped body.

In principle, the above-mentioned techniques have proven their worth in the production of refractory ceramic products. However, difficulties are often encountered when it comes to releasing the shaped green body from the resilient mould, transporting the green body to the site of use of the functional product to be produced from the green body, and arranging the green body at the site of use. This is because the un-fired green body is very sensitive, and therefore it can be easily damaged or even destroyed in conjunction with these treatment steps.

The object of the invention is to provide a technique by means of which a refractory batch for producing a refractory ceramic shaped body can be shaped and at the same time can be transported to the later site of use of the refractory ceramic product producible from the batch, wherein at the same time the risk of damage to, or destruction of the shaped, but as yet un-fired batch is lower than in the prior art.

In order to solve this problem, a system for treating a refractory batch is provided in accordance with the invention, said system comprising the following features:

a mould, which comprises the following features:
the mould is designed to receive a refractory batch and consists at least in part of a moisture-permeable material;
a refractory batch, which is received in the mould;
at least one portion which, as considered over the cross-sectional area of the system, consists exclusively of moisture-permeable material and refractory batch.

A basic concept of the system according to the invention lies in shaping a refractory batch for producing a refractory ceramic product, in particular a refractory ceramic product in the form of a functional product, in that said batch is not shaped by isostatic pressing of the refractory batch in a resilient mould to form a green body, and instead by introducing the refractory batch into a mould consisting at least in part of a moisture-permeable material, such that a shaped green body is formed from the refractory batch in such a way that the refractory batch automatically clings to the mould.

A further basic concept of the invention lies in the fact that the mould consists at least in part of a moisture-permeable material. This moisture permeability of the material of the mould makes it possible for the refractory batch to dry in the mould, such that it does not have to be removed from the mould in order to be dried, as is the case with isostatic pressing.

This makes it possible for the system according to the invention to be transported in its entirety to the site of use of a refractory ceramic product to be produced from the batch, and to be arranged there. A particular advantage of this possibility for transporting the system also lies in particular in the fact that the batch received in the mould during this transport and arrangement is protected by the mould against damage or destruction during the transport and the arrangement.

In order to receive the refractory batch, the mould of the system according to the invention is formed in such a way that it comprises a cavity, into which the refractory batch can be introduced. The geometry or three-dimensional design of this cavity corresponds to the geometry or three-dimensional design of the refractory ceramic product producible from the refractory batch received in the mould or introduced into the cavity of the mould. The inner contour of the mould or the inner surface of the cavity of the mould thus corresponds to the geometry or the outer contour of the refractory ceramic product producible from the refractory batch received in the mould.

The mould is preferably formed in such a way that the refractory batch can be introduced into the mould or into the cavity of the mould as a result of the force of gravity. The mould is therefore preferably formed in such a way that the refractory batch can be introduced into the mould without any other forces or aids, i.e. for example without using pumps or presses. In this regard, the mould is preferably formed in such a way that the refractory batch can be introduced from above into the mould or into the cavity of the mould. The mould or the cavity of the mould is preferably formed in such a way that the refractory batch automatically spreads fully in the mould or fully fills the cavity of the mould. In this regard, the cavity of the mould for example does not have any other parts or portions that cannot be filled by the refractory batch when said batch is introduced into the cavity of the mould.

In order to enable drying of the refractory batch in the mould, the mould is formed at least in part of moisture-permeable material. A system according to the invention hereby makes it possible for moist constituents of the refractory batch received in the mould to diffuse through the moisture-permeable material of the mould and, after having passed through the material, to escape into the surrounding environment, whereby the refractory batch received in the mould can dry.

In the sense of the present invention, the term “moisture-permeable” denotes material that allows moisture to diffuse therethrough. Here, the term “moisture” denotes in particular moist constituents of the refractory batch received in the mould, that is to say in particular water or plastic binder, which the batch comprises for example for adjustment of its plasticity or for its formability. In the sense of the present invention, the term “moisture-permeable” therefore denotes in particular materials that are permeable to water vapour or open to the diffusion of water vapour. For example, the moisture-permeable material can be formed in such a way that it has a low steam diffusion resistance, for example a water vapour diffusion resistance factor μ according to DIN EN ISO 12572:2015-01 of less than 100, in particular for example also less than 50, 20 or less than 10.

In order to enable the most efficient and comprehensive drying possible of the refractory batch received in the mould, the mould preferably consists completely or predominantly of moisture-permeable material of this kind. The mould preferably consists of moisture-permeable material to such an extent that the refractory batch received in the mould can be dried fully in the mould, more specifically in particular within a short, economically justifiable period of time. Insofar as the mould consists predominantly of moisture-permeable material, it is provided in particular that the mould is formed predominantly from moisture-permeable material in such a way that a refractory batch received in the mould or a green body received in the mould and formed from the batch bears with at least 50% of its surface (in relation to the total surface of the batch or the green body) against moisture-permeable material, particularly preferably with at least 60, 70, 80 or 90% of its surface.

The moisture-permeable material can consist of one or more materials. For example, the material can be formed as a composite material formed of a number of materials.

In accordance with a preferred embodiment, the moisture-permeable material is flammable material. The moisture-permeable material is particularly preferably flammable material having an ignition temperature of less than 500° Celsius, in particular having an ignition temperature of less than 480°, 460°, 440°, 420°, 400° or less than 380° Celsius. The material can also have an ignition temperature of more than 100° Celsius, that is to say for example also an ignition temperature of more than 120°, 140°, 160°, 180° or more than 200° Celsius.

The particular advantage of flammable materials of this kind lies in particular in the fact that the system according to the invention in this case can be arranged at the site of use of a refractory ceramic product producible from the refractory batch, and the flammable material of the mould then ignites and burns off when the system is exposed to heat. Once the material has burned off, the portions of the refractory batch or of the green body shaped formed from the refractory batch in the mould previously covered by the material are already at the site of use of the refractory ceramic product producible from the batch, without the refractory batch having to be removed beforehand from the mould in this respect. Particularly good protection of the green body shaped from the refractory batch is ensured hereby, since said green body does not have to be removed from the mould prior to its arrangement at the site of use of the refractory ceramic product to be produced from the refractory batch.

In accordance with one embodiment, the moisture-permeable material of the system according to the invention consists of organic material, for example of pulp-based material, for example paper, paperboard or cardboard.

The material particularly preferably consists of cardboard.

The term “cardboard” is understood herein quite generally to mean thick paper. In this regard, cardboard for example can consist of a number of layers of paper, for example also of a number of layers of paper of different composition and/or different thickness. The plurality of layers of paper for example can be glued to one another or pressed with one another without adhesive (couched). One or more of the layers of paper can also be three-dimensionally shaped, for example folded, corrugated or otherwise profiled, such that cardboard from which the material of the mould is made can be provided for example also in the form of paperboard.

Insofar as the material of the system according to the invention consists of cardboard, this can have a grammage for example in the range of from 1000 to 3000 g/m², i.e. in particular for example also a grammage of at least 1000, 1500, 1800 or 2000 g/m², and for example also a grammage of at most 3000, 2500 or 2300 g/m².

It has been found in accordance with the invention that material of the mould of the system according to the invention consisting of cardboard has particularly good properties if the thickness of said cardboard lies within a specific range. It has thus been found in accordance with the invention that the dimensional stability of a mould cannot be sufficient if the thickness of the cardboard is less than 1 mm. In this regard, the material of the mould, insofar as this is provided in the form of cardboard, preferably has a thickness of at least 1 mm. It has also been found in accordance with the invention that a satisfactory moisture permeability of cardboard can no longer be provided if the thickness of the cardboard is greater than 6 mm. In this regard, the material of the mould, insofar as this is provided in the form of cardboard, preferably has a thickness of at most 6 mm. In this regard, the material of the mould, insofar as this is provided in the form of cardboard, preferably has a thickness in the range of from 1 to 6 mm, particularly preferably a thickness of at least 1.0 or 1.5 or 2.0 or 2.5 mm, and preferably at most a thickness of 6.0 or 5.5 or 5.0 or 4.5 or 4.0 or 3.5 mm. In particular, the thickness of the cardboard can be 3 mm.

The use of cardboard as moisture-permeable material is particularly advantageous also for environmental reasons. This is true in particular both in respect of its compostability and in respect of its burn-off behaviour.

The mould of the system according to the invention is preferably dimensionally stable or inherently stable, in particular also when a refractory batch is received in the mould. An inherent stability of the mould of this kind ensures that the refractory batch shaped into a green body by introduction of the refractory batch into the mould achieves a defined form and is not potentially deformed by a deformation of the mould on account of a lack of inherent stability. In this regard, the mould preferably consists of an inherently stable material, and in this regard for example does not consist of a resilient material, such as an elastomer or for example a gum or rubber. The moisture-permeable material of the mould is particularly preferably also inherently stable.

In accordance with one embodiment, it is provided that the moisture-permeable material made of cardboard has a plastics coating at least in part. A plastics coating of this kind can be used in particular to achieve the dimensional stability or inherent stability of the mould, in particular also if the cardboard absorbs moisture during the drying of the refractory batch and thus loses strength. In accordance with a preferred embodiment, the moisture-permeable material made of cardboard comprises a coating formed from a thermoplastic. This coating can be comprised by the cardboard on the inner side (that is to say on its inner surface), on the outer side (that is to say on its outer surface), or in the form of a layer within the cardboard or for example also in the form of a combination of these coatings. The cardboard particularly preferably has a coating of this kind formed from a thermoplastic in the form of an outer coating, that is to say on its surface exposed to the surrounding environment. So as not to significantly compromise the cardboard by means of an outer coating of this kind formed from a thermoplastic, it can be provided in particular that the cardboard comprises the coating only in portions.

The advantage of a coating of this kind in the form of a thermoplastic, besides the increase to the inherent stability of the mould, also lies in particular in the fact that said coating breaks down and volatilises at lower temperatures, in particular also at temperatures within the above-mentioned ignition temperatures of the moisture-permeable material, such that the plastics material can volatilise when the mould is exposed to heat, in particular also with arrangement of the system at the site of use of a refractory ceramic product producible from the batch.

A thermoplastic for the coating can be provided for example from polyethylene (PE), polypropylene (PP) or polystyrene (PS). A thermoplastic is particularly preferably provided in the form of polyethylene.

In accordance with one embodiment, the moisture-permeable material of the system according to the invention consists of perforated material, or the moisture-permeable material comprises a perforation. The moisture-permeable material therefore comprises a perforation, for example in the form of holes and/or slits. As a result of this perforation, moist constituents of the batch received in the mould can diffuse through or vaporise. Here, the perforation is dimensioned in such a way that solely moist constituents of this kind of the batch received in the mould can diffuse or vaporise through the perforation, whereas grainy or solid constituents of the batch cannot pass through the perforation.

The mould of the system according to the invention is preferably formed in such a way that the moisture-permeable material comprises a surface exposed to the surrounding environment, from which moisture can evaporate into the surrounding environment. The moisture-permeable material of the mould therefore for example is not covered outwardly, that is to say on its surface exposed to the surrounding environment, in such a way as to prevent or even hinder evaporation from the surface. It is hereby ensured that moist constituents of the batch diffused through the moisture-permeable material can evaporate into the surrounding environment, such that the refractory batch can dry effectively in the mould.

The system according to the invention comprises at least one portion which, as considered over the cross-sectional area of the system, consists exclusively of moisture-permeable material and refractory batch. In other words: the system comprises at least one portion, in which a cross-section can be taken through the system, wherein the system along this cross-section comprises exclusively solid material in the form of the moisture-permeable material and the refractory batch. Gaseous or liquid constituents, for example air, other gas or binder, can of course be provided in this portion, for example in cavities or pores.

In accordance with the invention it has been determined specifically that the drying of the refractory batch in the mould and the subsequent firing of the refractory batch can be disadvantageously hampered if the system comprises other solid material besides the refractory batch and the moisture-permeable material. This is because other solid materials of this kind can act during the drying and firing of the refractory batch as interference points, which can lead to the formation of cracks in the batch and in the refractory ceramic product fired therefrom, whereby not only can the properties worsen (in particular also the strength of the refractory ceramic product to be fired from the refractory batch), but also the product can be damaged or even destroyed.

In particular, it is provided here that this portion consisting exclusively of refractory batch and moisture-permeable material is fully surrounded at the edge by the moisture-permeable material of the mould. The refractory batch in the region of this portion can hereby be shaped in a manner encompassed by the moisture-permeable material of the mould, and at the same time can dry well, wherein the refractory batch in the region of this portion also cannot be disadvantageously hampered by interfering points during drying and firing.

In accordance with the invention it can also be provided in particular that the system predominantly also completely consists exclusively of moisture-permeable material and refractory batch, as considered over the cross-sectional area of the system.

In particular against this background as well, the system according to the invention has proven to be particularly advantageous for producing refractory shaped functional products, in particular for producing refractory shaped functional products for continuous casting of steel, which products are produced largely or completely from refractory batch, i.e. for example ladle shrouds (ladle distribution pipe) or submerged nozzles. However, in this regard the system according to the invention has proven to be particularly advantageous for producing monoblock stoppers. In this regard, the batch of the system according to the invention received in the mould can constitute in particular a green body for producing monoblock stoppers or a shaped green body from which a monoblock stopper can be fired without further shaping.

As is known, the above-mentioned refractory ceramic products in the form of ladle shrouds, submerged nozzles or monoblock stoppers extend along a longitudinal axis. Accordingly, the batch received in the mould of the system according to the invention for producing these products extends along a longitudinal axis corresponding to the longitudinal axis of the product to be produced from said batch. In accordance with a development of this inventive concept, it can be provided that the system comprises at least one portion which, as considered over its cross-sectional area, consists exclusively of moisture-permeable material and refractory batch, wherein the cross-sectional area intersects this longitudinal axis of the batch or green body. The cross-sectional area preferably intersects the longitudinal axis at right angles. Here, it can also be provided in particular that the system consists predominantly or also completely along this longitudinal axis, as considered over the cross-sectional area of the system, exclusively of moisture-permeable material and refractory batch. For example, the system can consist along at least 50%, that is to say for example also along at least 60%, 70%, 80% or 90% of the length of the longitudinal axis, as considered over the cross-sectional area of the system, exclusively of moisture-permeable material and refractory batch.

It can be provided that the mould of the system according to the invention comprises moisture-permeable material not only for the shaping of the outer contour of the batch received therein, but also for the shaping of any inner contours of the batch, for example insofar as the green body formed from the batch is to have inner cavities or any other geometries. For example, the mould in this respect can also comprise moisture-permeable material for shaping the inner passage of a submerged nozzle or for shaping a gas channel in a monoblock stopper.

The system according to the invention is suitable in principle for the treatment of any refractory batch known from the prior art from which a refractory ceramic product can be produced. In this regard, in principle any refractory batch known from the prior art for producing a refractory ceramic product can be received in the mould.

In this regard the refractory batch is quite generally a refractory batch, that is to say a batch for producing a refractory ceramic product.

As already mentioned, it has been found in accordance with the invention that the system according to the invention is particularly suitable for shaping refractory batches for producing refractory ceramic products in the form of functional products, in particular functional products for the casting of steel.

In this regard, it can be provided preferably that the refractory batch received in the mould is a batch for producing a refractory ceramic functional product in systems for casting steel. In this regard, the refractory batch received in the mould can be particularly preferably a refractory batch for producing a refractory shaped functional product in the form of a ladle shroud (ladle distribution pipe) or a submerged nozzle, and particularly preferably a batch for producing a refractory shaped functional product in the form of a monoblock stopper.

In accordance with one embodiment, the refractory batch is a refractory batch for producing a sintered refractory ceramic product. The refractory batch can particularly preferably be a refractory batch from which a carbon-bonded refractory ceramic product can be produced. In this regard, the refractory batch for example can be a refractory batch based on at least one oxide, which is selected from the following group: aluminium oxide (Al₂O₃), magnesium oxide (MgO), silicon oxide (SiO₂) and zirconium oxide (ZrO₂). Insofar as the refractory batch is a refractory batch from which a carbon-bonded refractory ceramic product can be produced, the refractory batch also comprises carbon.

With regard to the specific composition and raw material selection, reference can be made, for the forming of a refractory batch of this kind, to the refractory batches known from the prior art and based on these substances. For example, the total mass of carbon and the group of oxides constituted by aluminium oxide, magnesium oxide, silicon oxide and zirconium oxide can lie in the range of from 80 to 100 mass % or in the range of from 90 to 100 mass %, in relation to the total mass of the refractory batch. Carbon can be present for example in a range of from 0 to 40 mass %, 5 to 30 mass %, or in the range of from 5 to 20 mass %, in relation to the total mass of the refractory batch. The proportion of the total mass of oxides constituted by aluminium oxide, magnesium oxide and zirconium oxide can lie for example in a range of from 60 to 100 mass %, in a range of from 70 to 95 mass %, or in a range of from 80 to 95 mass %, In relation to the total mass of the refractory batch.

The batch can be present for example in the form of a refractory batch for producing shaped or unshaped refractory ceramic products.

In particular, reference can also be made in this regard for example to the refractory batches known from the prior art which are known for the isostatic pressing of refractory ceramic functional products in the form of monoblock stoppers, ladle shrouds, or submerged nozzles. In particular, reference can be made to refractory batches that are known for the production of monoblock stoppers. In this regard, the refractory batch for producing a refractory shaped functional product is formed as a monoblock stopper, a ladle shroud, or a submerged nozzle.

In accordance with one embodiment, the system comprises holding means. These holding means can be formed in particular in such a way that the system can be held via the holding means. Corresponding holding means simplify the holding, the transport, and the arrangement of the system at the site of use of a refractory ceramic product producible from the refractory batch of the system.

In accordance with one embodiment, it is provided that holding means of this kind are arranged on the mould of the system. For example, holding means of this kind can be arranged externally on the mould, for example in the form of metallic handling means. So as not to damage the mould, handling means of this kind are provided for example in the manner of sleeves comprising the mould.

In accordance with one embodiment, it can be provided that the system comprises holding means which are formed in the refractory batch. In this embodiment the holding means can constitute simultaneously the means used to hold the refractory ceramic product producible from the refractory batch during use thereof. In accordance with a preferred embodiment it is provided that a holding means in the form of a metal inner thread is formed in the refractory batch, for example in the form of a nut. Means for holding the refractory ceramic products produced from the refractory batch can be screwed into this thread.

The mould can consist in part of non-moisture-permeable material. Non-moisture-permeable material of this kind can be provided in particular in order to provide the mould, as a result of this non-moisture-permeable material, with properties which it cannot be provided with by moisture-permeable material. For example, the mould can consist in part of non-moisture-permeable material of this kind in order to increase the inherent stability or strength of the mould. For example, the mould can also consist in part of non-moisture-permeable material of this kind in order to form specific geometries of the cavity in the mould for the shaping of the refractory batch which could not be formed by moisture-permeable material. Non-moisture-permeable material of this kind can be formed for example from metal, for example steel, or plastic.

Insofar as the mould, as described above, for example as moisture-permeable material comprises a tube, for example made of cardboard, it can be provided that the two ends of the tube are closed by closures or caps, wherein at least one end, preferably both ends, can be closed by closures made of a non-moisture-permeable material of this kind. In an embodiment of this kind, a cavity is defined by the inner wall of the tube and by surface portions of the closures, in which cavity the batch can be received. The refractory batch can be shaped here into a green body by bearing against the inner wall of the tube and said surface portions. So as to be able to introduce the refractory batch into the cavity, at least one of the closures can have an opening. An embodiment of the invention of this kind is suitable in particular for producing monoblock stoppers, wherein the cylindrical lateral surface of the monoblock stopper is shaped by the inner wall of the tube and the complex geometry of the lower and upper stopper end is shaped by surface portions of the closures. A variant of a system of this kind will be explained further below as an exemplary embodiment.

Insofar as the mould comprises non-moisture-permeable material, it can be provided that this material is removed from the mould before the mould is acted on by heat, in particular also insofar as the non-moisture-permeable material is not flammable.

The invention also relates to the use of the system according to the invention for treating a refractory batch for producing a refractory ceramic functional product in the form of a monoblock stopper, a ladle shroud, a submerged nozzle, or an exchangeable nozzle.

The use can be performed in accordance with the features disclosed for the invention.

The invention also relates to a method for treating a refractory batch, said method comprising the following steps:
providing a mould disclosed herein;
introducing a refractory batch into the mould;
leaving the refractory batch to dry in the mould.

The mould and the refractory batch can be formed as described herein.

The refractory batch can be introduced into the mould in particular by means of the force of gravity, and in particular without pumps or other introduction means.

In order to ensure complete filling of the mould or of the cavity of the mould by the refractory batch, it can be provided that the mould is shaken once the refractory batch has been introduced into the mould.

The refractory batch can be left to dry in the mould for example at room temperature, or the refractory batch also can be dried by applying heat to the mould, for example in a dryer.

In order to produce a fired refractory ceramic product from the refractory batch dried in the mould, the method can comprise the following further steps:

arranging at least part of the mould at the site of use of a refractory ceramic product producible from the refractory batch;
exposing the mould arranged at the site of use to heat in order to produce a refractory ceramic product from the refractory batch.

The mould is therefore arranged at the site of use of a refractory ceramic product producible from the refractory batch with the refractory batch filled into said mould. As mentioned before, this has the particular advantage that the refractory batch filled into the mould of the system and dried there does not have to be removed from the mould prior to the arrangement of the batch at the site of use of the refractory ceramic product producible from the refractory batch.

In particular, the site of use can be a continuous casting system, and in particular a tundish. This is true in particular insofar as the refractory ceramic product producible from the batch, as mentioned before, is a monoblock stopper, a ladle distribution pipe, or a submerged nozzle.

The feature in accordance with which “at least part” of the mould is arranged at the site of use of a refractory ceramic product producible from the refractory batch conveys that the mould can be arranged at the site of use fully or only partially, that is to say only in respect of certain portions.

In accordance with one embodiment, it can be provided in this regard that the mould with the dried refractory batch received therein is arranged fully at the site of use. This embodiment lends itself in particular if the mould consists completely of flammable material.

In accordance with an alternative embodiment, it can be provided in this regard that the mould with the dried refractory batch received therein is arranged in part at the site of use. This embodiment lends itself in particular if the mould consists partially of flammable material and partially of non-flammable material. In this case, it can be provided that, before the mould arranged at the site of use is exposed to heat, at least those parts of the mould formed from non-flammable material are removed.

The mould is exposed to heat preferably via the apparatus at which the cited use of the refractory ceramic product producible from the refractory batch is located, i.e. in particular for example a tundish. Insofar as the moisture-permeable material of the mould, as mentioned before, is flammable, this material burns off when it reaches its ignition temperature, such that it does not have to be removed from the shaped refractory batch by a further method step. The subsequently exposed, shaped batch is ultimately fired to form a refractory ceramic product by further exposure to heat, i.e. in particular by further heating of the tundish.

The system according to the invention and the method according to the invention have proven to be particularly advantageous in particular for producing a carbon-bonded refractory ceramic product from the refractory batch since the moisture-permeable material of the mould acts as oxidation protection for the received refractory batch until said material has reached its ignition temperature.

As a result of the system according to the invention and the method according to the invention, the oxidation protection of an oxidation-sensitive refractory batch it is thus improved significantly compared to the prior art.

The invention also relates to the use of a mould disclosed herein for receiving a refractory batch. The mould and the refractory batch can be formed as described herein, and the use can be implemented according to the features disclosed herein, in particular also the method features disclosed herein.

Further features of the invention will become clear from the claims, the embodiments, the drawings and the associated description of the drawings.

All of the features of the invention can be combined with one another arbitrarily, individually or in combination.

Two embodiments of the invention will be explained in greater detail hereinafter.

The embodiments each relate to a system according to the invention for treating a batch for producing a refractory ceramic product in the form of a functional product for a continuous casting system. Specifically, the embodiments each relate to a system for treating a batch for producing a monoblock stopper.

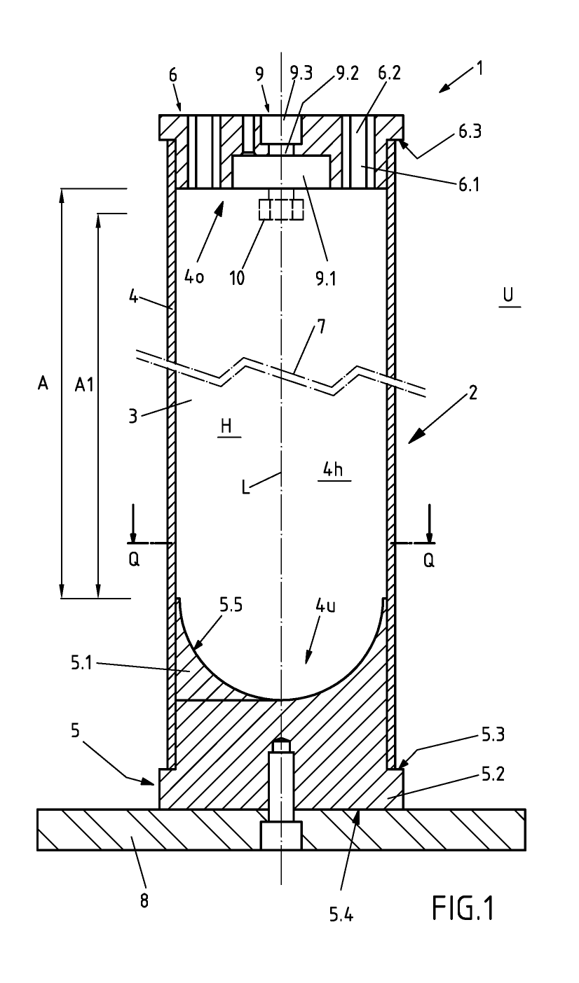

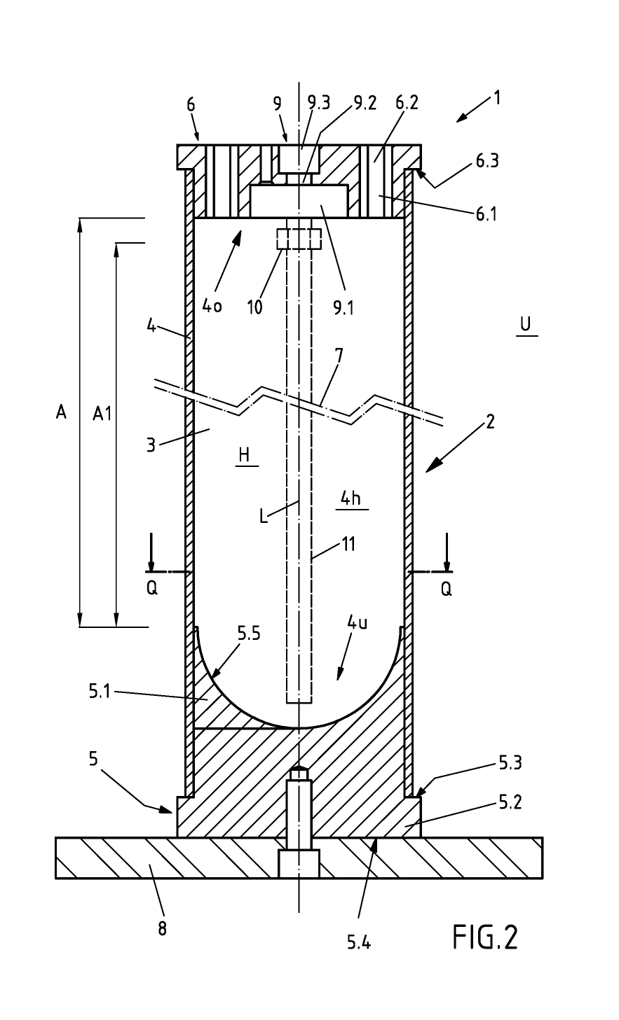

FIGS. 1 and 2 serve to visualise the exemplary embodiments.

Said figures show, in a heavily schematised manner:

FIG. 1 a first exemplary embodiment of a system for treating a batch for producing a monoblock stopper in a lateral sectional view, and

FIG. 2 a second exemplary embodiment of a system for treating a batch for producing a monoblock stopper in a side sectional view.

The system 1 according to FIG. 1 comprises a mould 2 and a refractory batch 3 received in the mould 2.

The mould 2 comprises a circular-cylindrical tube 4 made of cardboard and a first closure 5 and a second closure 6, which are each made of steel. The tube 4 is disposed in FIG. 1 in an upright position, that is to say with a vertically extending longitudinal axis L of the tube 4. The tube 4 is closed at its lower end 4u by the first closure 5 and at its upper end 4o by the second closure 6.

The tube 4 of the mould 2 is formed from a cardboard shaped in a circular-cylindrical manner with a clear diameter of 131 mm. The wall thickness of the cardboard is 3 mm. The length of the tube 4 is 1,590 mm, wherein the length of the tube 4 in the illustration according to FIG. 1—indicated by the dashed lines 7 with a zigzag course—has been shown shortened. The tube 4 encloses an interior 4h inside the tube 4. The cardboard from which the tube 4 is made is moisture-permeable hard paper, which is glued to itself in a number of layers. The grammage of the cardboard of the tube 4 is 2.13 kg/m².

At its lower end 4u, the tube 4 is tightly closed by the first closure 5. To this end, the first closure 5 comprises a portion 5.1, which is inserted into the lower end 4u of the tube 4. Here, the portion 5.1 has a circular-cylindrical outer circumference with a diameter corresponding to the clear diameter of the tube 4, such that the tube 4 at its lower end 4u bears with its inner wall flat against the circumference of the portion 5.1 of the first closure 5. The portion 5.1 of the first closure 5 is adjoined by a second portion 5.2, which protrudes circumferentially beyond the first portion 5.1 and hereby forms a contact edge 5.3, against which the tube 5 abuts with its lower end face. On the side 5.4 of the first closure 5 facing away from the tube 4, a metal base plate 8 is screwed against the first closure 5. The base plate 8 is disc-shaped and has a diameter of 300 mm. The mould 2 can be placed securely on a substrate via the base plate 8.

On its side facing towards the cavity 4h of the tube 4, the first attachment 5 has a shell-shaped recess 5.5, which extends concavely into the portion 5.1.

The second closure 6 is composed in a number of parts from individual steel elements. The second closure 6 has a first portion 6.1, which is inserted into the upper, end-face portion 4o of the tube 4. Similarly to the portion 5.1 of the first closure 5, the first portion 6.1 of the second closure 6 also has a circular-cylindrical outer circumference with a diameter corresponding to the clear diameter of the tube 4, such that the tube 4 at its upper end 4o bears flat via its inner wall against the circumference of the portion 6.1 of the second closure 6. The first portion 6.1 is adjoined by a second portion 6.2 of the second closure 6, which protrudes beyond the first portion 6.1 at the outer circumference thereof. Here, the second portion 6.2 forms contact edges 6.3, against which the tube 4 abuts via its upper end face. The second closure 6 has a bore concentric with the longitudinal axis L of the tube 4, which bore comprises three portions 9.1, 9.2 and 9.3 with different diameters. Here, the first portion 9.1 of the bore 9 with the largest diameter is arranged on the side facing towards the interior 4h of the tube 4 and the portion 9.3 of the bore 9 with an average diameter is arranged in the second closure 6 on the side facing away from the interior 4h of the tube 4. The portion 9.2 of the bore 9 with the smallest diameter extends between these two portions 9.1 and 9.3.

The closure 6 is also used in particular for positioning a nut that can be formed in the refractory batch 3 and into which a rod can be screwed (indicated by the dashed line 10), via which a monoblock stopper producible from the refractory batch 3 can be held and moved during its later use at the tundish.

The inner wall of the interior 4h of the tube 4 which is not filled by the first and second closure 5, 6, the surface of the shell-shaped recess 5.5 of the first closure 5, the surface portions of the second closure 6 facing towards the interior 4h of the tube 4, and the surface of the bore 9 form a cavity H in the mould 2.

The cavity H is filled fully with the batch 3. The refractory batch 3 is a refractory casting compound for producing a carbon-bonded refractory ceramic functional product in the form of a monoblock stopper. The refractory batch 3 is composed of 82.5 mass % fused magnesia, 12 mass % graphite, 3.0 mass % binder, 2.0 mass % antioxidant, and 0.5 mass % silicon dioxide powder, in each case in relation to the total mass of the batch 3. The fused magnesia is provided in a purity of 97 mass % MgO. The graphite, as carbon carrier of the refractory batch 3, comprises a proportion of carbon of 94 mass %. The binders are a mixture of novolac and pitch. Aluminium powder is provided as antioxidant. This results in a mass proportion of MgO in the batch of approximately 80.0 mass % and a proportion of carbon in the refractory batch 3 of approximately 11.3 mass %, in each case in relation to the total mass of the refractory batch 3.

The refractory batch 3 was filled into the cavity H through the bore 9 in the second closure 6, until it completely filled the cavity H. The mould 2 was then shaken, such that the refractory batch 3 settled further and compacted.

The factory batch 3 was then left to dry in the mould 2. During drying, moist components of the refractory batch 3 diffused through the moisture-permeable tube 4 outwardly and evaporated on the surface of the tube 4 exposed to the surrounding environment U. Further moist components of the refractory batch 3 evaporated through the bore 9. This diffusion and evaporation continued until the refractory batch 3 was completely dry. A green body shaped by the mould 2 and formed from the refractory batch 3 for producing a carbon-bonded monoblock stopper was then obtained.

Since the first closure 5 and the second closure 6 are not flammable parts of the mould 2, the first closure 5 and the second closure 6 were removed from the mould 2 and the refractory batch 3 following the drying of the refractory batch 3. In spite of the undercut of the refractory batch 3 in its portion formed by the bore 9, the removal of the second closure 6 from the batch was possible due to the multi-part nature of the closure 6.

As shown clearly in FIG. 1, the mould 2 consists of moisture-permeable material in the form of the tube 4 made of cardboard from the upper edge of the first closure 5 to the lower edge of the second closure 6. This portion of the mould 2 is denoted by reference sign A. Furthermore, along the portion A1 (which extends from the upper edge of the first closure 5 to the lower edge of the nut 10 formed in the refractory batch 3) of this portion A, the batch 3 extends over the entire cross-sectional area of the mould 3. The system 1, as considered over any cross-sectional area of the system 1 along this portion A1, thus consists exclusively of moisture-permeable material in the form of the tube 4 made of cardboard and refractory batch 3. In this portion A1, a cross-section can be taken through the system 1, wherein this cross-sectional area is fully encompassed at the edge by the cardboard of the tube 4. An example of a cross-section of this kind is shown by the cross-section along the sectional area Q-Q.

As mentioned before, the batch 3 of the system 1 constitutes a green body for producing a monoblock stopper, which can be fired without further shaping to form a monoblock stopper. This monoblock stopper, which can be fired from the batch 3, extends along a longitudinal axis corresponding to the longitudinal axis L of the tube 4 and at the same time also the longitudinal axis L of the batch 3 or of the green body formed from the batch 3 once said batch has dried. Along the portion A1, the system 1, as considered over a cross-sectional area intersecting this longitudinal axis L at right angles, consists exclusively of moisture-permeable material in the form of the cardboard of the tube 4 and refractory batch 3. Here, the system 1 consists to an extent of significantly more than 50% of the length of the longitudinal axis L, as considered over the cross-sectional area of the system 1, exclusively of moisture-permeable material in the form of the cardboard of the tube 4 and refractory batch 3.

The system according to FIG. 2 is largely identical to the system according to FIG. 1, and therefore the matching components of both systems have been provided with the same reference signs.

In contrast to the system 1 according to FIG. 1, however, the system 1 according to FIG. 2 also comprises a tube 11, which is arranged coaxially with the longitudinal axis L of the tube 4 or coaxially with the longitudinal axis L of the green body in the mould 2 formed from the batch 3. The tube 11 is formed from the same cardboard from which the tube 4 is also formed. The tube 11 has a clear diameter of approximately 10 mm. In the system 1 according to FIG. 2 the region of the cavity H occupied by the tube 11 is not filled with the batch 3.

In order to produce the monoblock stopper from the dried, shaped refractory batch 3 of the systems 1 according to FIGS. 1 and 2, the mould 2 or the tube 4 of the mould 2 with the batch 3 received therein remaining once the first and second closures 5, 6 have been removed is arranged at the site of use of the monoblock stopper producible from the refractory batch 3 in the tundish of a continuous casting system. A rod for later holding and moving of the monoblock stopper was firstly screwed into the nut formed in the refractory batch 3, and the mould 2 was exposed to heat by heating the tundish. Once the ignition temperature of the cardboard of the tube 4 of approximately 360° Celsius was reached, the cardboard ignited and burned off fully; in the system 1 according to FIG. 2, once the ignition temperature of the cardboard of the tube 11 had been reached, this cardboard also ignited and likewise burned off fully. Following further heating of the tundish, a carbon-bonded monoblock stopper was ultimately produced from the refractory batch 3. In the system 1 according to FIG. 2 the space initially taken up by the tube 11 in this case formed a gas channel for introducing gas into the formed monoblock stopper.

1. A system for treating a refractory batch, comprising the following features:
1.1 a mould (2), comprising the following features:
1.1.1 the mould (2) is designed to receive a refractory batch;
1.1.2 the mould (2) consists at least in part of moisture-permeable material (4);
1.1.3 the material (4) is flammable;
1.1.4 the ignition temperature of the material (4) is less than 500° C.;
1.2 a refractory batch (3), which is received in the mould (2);
1.3 at least one portion which, as considered over the cross-sectional area of the system, consists exclusively of moisture-permeable material (4) and refractory batch (3).

2. The system according to claim 1, in which the material (4) consists of cardboard.

3. The system according to claim 2, in which the cardboard comprises a plastics coating at least in part.

4. The system according to claim 1 comprising a refractory batch (3) for producing a refractory shaped functional product in the form of a monoblock stopper, a ladle shroud, or a submerged nozzle.

5. The system according to claim 1, in which the batch (3) received in the mould (2) is a green body for producing monoblock stoppers.

6. A method comprising:
treating a batch for producing a refractory shaped functional product in the form of a monoblock stopper, a ladle shroud, or a submerged nozzle, wherein the batch is treated using a system having the following features:
a mould (2), comprising the following features:
the mould (2) is designed to receive a refractory batch;
the mould (2) consists at least in part of moisture-permeable material (4);
the material (4) is flammable;
the ignition temperature of the material (4) is less than 500° C.;
a refractory batch (3), which is received in the mould (2);
at least one portion which, as considered over the cross-sectional area of the system, consists exclusively of moisture-permeable material (4) and refractory batch (3).

7. A method for treating a refractory batch comprising the following steps:
providing a mould, the mould having the following features:
the mould (2) is designed to receive a refractory batch;
the mould (2) consists at least in part of moisture-permeable material (4);
the material (4) is flammable;
the ignition temperature of the material (4) is less than 500° C.;
introducing a refractory batch into the mould;
leaving the refractory batch to dry in the mould.

8. The method according to claim 7, comprising the following further steps:
arranging at least part of the mould at the site of use of a refractory ceramic product producible from the refractory batch;
exposing the mould arranged at the site of use to heat in order to produce a refractory ceramic product from the refractory batch.

9. A method comprising:
using a mould to receive a refractory batch, the mould comprising the following features:
9.1 the mould is designed to receive the refractory batch;
9.2 the mould consists at least in part of moisture-permeable material.
